(19) United States
(12) Patent Application Publication
(10) Pub. No.: US 2025/0189151 A1
(43) Pub. Date: Jun. 12, 2025

(54) AIR CONDITIONER UNIT MANAGEMENT DEVICE AND AIR CONDITIONER UNIT MANAGEMENT METHOD

(71) Applicant: CARRIER JAPAN CORPORATION, Tokyo (JP)

(72) Inventors: Qing YANG, Shizuoka (JP); Toshiyuki TANAKA, Shizuoka (JP); Kei OGAWA, Shizuoka (JP)

(73) Assignee: CARRIER JAPAN CORPORATION, Tokyo (JP)

(21) Appl. No.: 19/062,462

(22) Filed: Feb. 25, 2025

Related U.S. Application Data
(63) Continuation of application No. PCT/JP2023/030999, filed on Aug. 28, 2023.

(30) Foreign Application Priority Data
Sep. 1, 2022 (JP) 2022-139063

(51) Int. Cl. F24F 11/30; F24F 11/63

(52) U.S. Cl. CPC F24F 11/30; F24F 11/63

(57) ABSTRACT

In an air conditioner unit management device and an air conditioner unit management method, the air conditioner unit management device is communicably connected to an air conditioner unit, and includes a management software storage section, a determination section, and an update processing execution section. The management software storage section is configured to store management software for managing the air conditioner unit. The determination section is configured to determine necessity of monitoring the air conditioner unit, based on an operation status of the air conditioner unit. The update processing execution section is configured to execute update processing of the management software by using update software when the update software for updating the management software is acquired, and when the determination section determines that the necessity of monitoring the air conditioner unit is low.

### CROSS-REFERENCE TO RELATED APPLICATIONS

The present application is a continuation of International Application No. PCT/JP2023/030999, filed on Aug. 28, 2023, and based upon and claims the benefit of priority from Japanese Patent Application No. 2022-139063, filed on Sep. 1, 2022, the entire contents of which are incorporated herein by reference.

### FIELD

Embodiments described herein relate generally to an air conditioner unit management device and an air conditioner unit management method.

### BACKGROUND

Conventionally, many buildings use a multi-type air conditioner unit in which a plurality of indoor units are connected to one outdoor unit. Large buildings such as commercial facilities and office buildings are equipped with air conditioning systems using a plurality of such multi-type air conditioner units.

An air conditioning system as described above is communicably connected to a management device installed in a remote place. The management device is equipped with management software for controlling and monitoring devices in the air conditioning system. The management device uses the management software to remotely control operation of indoor units and outdoor units in an air conditioning system, and to detect any abnormality in the indoor units or the outdoor units, and report it to a manager.

### BRIEF DESCRIPTION OF THE DRAWINGS

FIG. 1 is an overall view illustrating an air conditioning system using an air conditioner unit management device according to first to fourth embodiments.

FIG. 2 is a flowchart illustrating operation of a monitoring gateway device in the air conditioner unit management device according to the first embodiment.

FIG. 3 is a flowchart illustrating operation of a monitoring gateway device in the air conditioner unit management device according to the second embodiment.

FIG. 4 is a flowchart illustrating operation of a monitoring gateway device in the air conditioner unit management device according to the third embodiment.

FIG. 5 is a flowchart illustrating operation of a monitoring gateway device in the air conditioner unit management device according to the fourth embodiment.

### DETAILED DESCRIPTION

Management software mounted on a management device of an air conditioning system may need to be updated. However, the management device cannot monitor the air conditioning system to be managed while update processing of the management software is being executed. Therefore, in a conventional air conditioning system, if an abnormality occurs in an air conditioning system during update processing of the management software of the management device, the management device cannot detect the abnormality. In other words, in a conventional air conditioning system, a manager cannot recognize abnormality occurring during the update processing of the management software of the management device.

To provide an air conditioner unit management device and an air conditioner unit management method capable of executing update processing of management software mounted on the device while properly executing monitoring processing of an air conditioning system.

An air conditioner unit management device according to an embodiment is communicably connected to an air conditioner unit, and includes a management software storage section, a determination section, and an update processing execution section. The management software storage section is configured to store management software for managing an air conditioner unit. The determination section is configured to determine necessity of monitoring the air conditioner unit, based on an operation status of the air conditioner unit. The update processing execution section is configured to execute update processing of the management software by using update software when the update software for updating the management software is acquired, and when the determination section determines that the necessity of monitoring the air conditioner unit is low.

An air conditioner unit management method according to an embodiment, that uses an air conditioner unit management device communicably connected to an air conditioner unit, incudes storing management software for managing the air conditioner unit; and executing update processing of the management software by using update software when the update software for updating the management software is acquired, and when it is determined that the necessity of monitoring the air conditioner unit is low.

Hereinafter, some embodiments of an air conditioner unit management device and an air conditioner unit management method will be described in detail with reference to the drawings.

### Configuration of Air Conditioning System Using Air Conditioner Unit Management Device According to First Embodiment

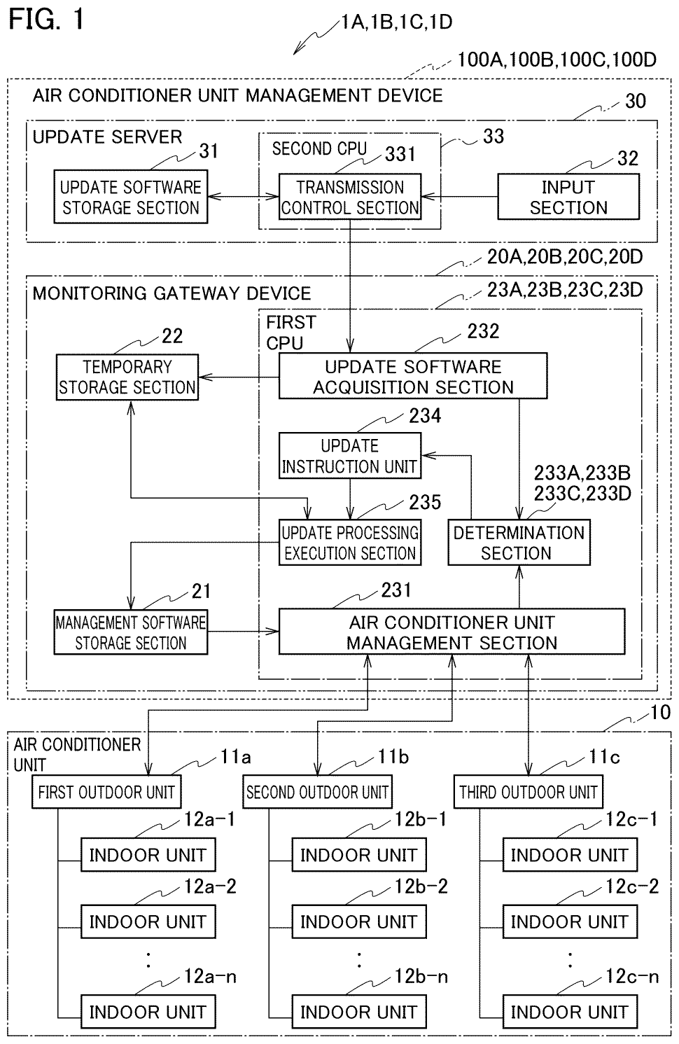

A configuration of an air conditioning system using an air conditioner unit management device according to a first embodiment will be described with reference to FIG. 1. An air conditioning system 1A includes an air conditioner unit 10, a monitoring gateway device 20A for managing the air conditioner unit 10, and an update server 30. In the present embodiment, an air conditioner unit management device 100A includes the monitoring gateway device 20A and the update server 30.

The air conditioner unit 10 is installed in a predetermined building, and has a plurality of devices. Specifically, the air conditioner unit 10 has a first outdoor unit 11a, n units of indoor units 12a-1 to 12a-n connected to the first outdoor unit 11a by refrigerant piping (not illustrated) and communication lines, a second outdoor unit 11b, n units of indoor units 12b-1 to 12b-n connected to the second outdoor unit 11b by the refrigerant piping and the communication lines, a third outdoor unit 11c, and n units of indoor units 12c-1 to 12c-n connected to the third outdoor unit 11c by the refrigerant piping and the communication lines.

Hereinafter, if it is not specified which of the outdoor units 11a, 11b, and 11c is referred to, it will be described as an outdoor unit 11. If it is not specified which of the indoor units 12a-1 to 12a-n, 12b-1 to 12b-n, and 12c-1 to 12c-n is referred to, it will be described as an indoor unit 12.

The present embodiment describes the air conditioner unit 10 having three outdoor units will be described. However, the number of outdoor units in the air conditioner unit 10 is not limited. The air conditioner unit 10 may have one, two, or four or more outdoor units. Further, the number of indoor units connected to each of the first outdoor unit 11a, the second outdoor unit 11b, and the third outdoor unit 11c is not particularly limited.

The monitoring gateway device 20A is communicably connected to the first outdoor unit 11a, the second outdoor unit 11b, and the third outdoor unit 11c in the air conditioner unit 10, and has a management software storage section 21, a temporary storage section 22, and a first CPU (Central Processing Unit) 23A. The management software storage section 21 stores management software for managing the air conditioner unit 10. The temporary storage section 22 temporarily stores update software acquired from the update server 30 as described below.

The first CPU 23A has an air conditioner unit management section 231, an update software acquisition section 232, a determination section 233A, an update instruction section 234, and an update processing execution section 235.

The air conditioner unit management section 231 acquires operation status information of devices (the outdoor units 11 and the indoor units 12) in the air conditioner unit 10, and manages the devices. The air conditioner unit management section 231 acquires the operation status information of the devices in the air conditioner unit 10 from the first outdoor unit 11a, the second outdoor unit 11b, and the third outdoor unit 11c by execution by the management software stored in the management software storage section 21. The operation status information of the devices in the air conditioner unit 10 acquired by the air conditioner unit management section 231 is displayed on a terminal connected to the air conditioner unit management device 100A.

The update software acquisition section 232 acquires update software transmitted from the update server 30, and stores it in the temporary storage section 22.

When the update software acquisition section 232 acquires update software, the determination section 233A acquires the operation status information of the devices in the air conditioner unit 10 acquired by the air conditioner unit management section 231. Then, the determination section 233A determines the necessity of monitoring the air conditioner unit 10, based on the acquired operation status information.

When the determination section 233A determines that the necessity of monitoring the air conditioner unit 10 is low, the update instruction section 234 determines that the management software can be updated. Then, the update instruction section 234 sends an update instruction of the management software to the update processing execution section 235.

When the update processing execution section 235 acquires the update instruction, the update processing execution section 235 executes update processing of the management software by using the update software stored in the temporary storage section 22.

The update server 30 is communicably connected to the monitoring gateway device 20A, and has an update software storage section 31, an input section 32, and a second CPU 33.

The update software storage section 31 stores the update software for updating the management software. The input section 32 inputs operation information of the administrator and the like to the second CPU 33. The second CPU 33 has a transmission control section 331 which transmits the update software stored in the update software storage section 31 to the monitoring gateway device 20A, based on the operation information input from the input section 32.

### Operation of Air Conditioning System Using Air Conditioner Unit Management Device According to First Embodiment

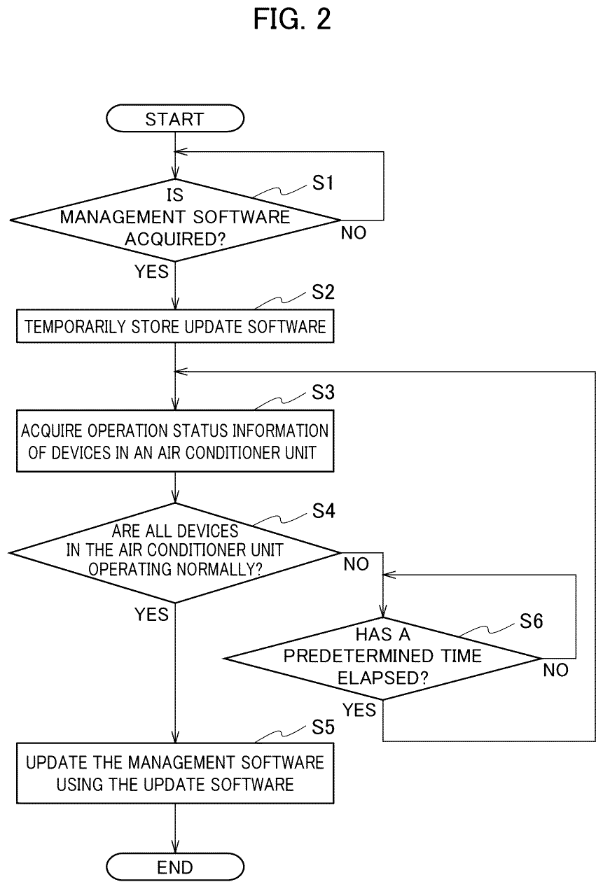

Next, operation of the air conditioning system 1A using the air conditioner unit management device 100A according to the present embodiment will be described. FIG. 2 is a flowchart illustrating operation performed by the monitoring gateway device 20A during the operation of the air conditioning system 1A.

During the operation of the air conditioning system 1A, the air conditioner unit management section 231 of the monitoring gateway device 20A acquires operation status information of the devices (the outdoor units 11 and the indoor units 12) in the air conditioner unit 10 from the first outdoor unit 11a, the second outdoor unit 11b, and the third outdoor unit 11c at predetermined time intervals, and manages the devices using the management software. The operation status of the devices in the air conditioner unit 10 is displayed as the operation status information on a display section of a terminal connected to the air conditioner unit management device 100A. A manager can recognize the status of the devices in the air conditioner unit 10 by visually confirming the information displayed on the display section. The display section may also be provided in the monitoring gateway device 20A. For the display section, a display using a liquid crystal screen or an LED lamp may be used.

When the manager operates the input unit 32 to instruct the transmission of management software while the air conditioning system 1A is in operation, the transmission control section 331 acquires update software stored in the update software storage section 31, and transmits it to the monitoring gateway device 20A.

In the monitoring gateway device 20, the update software acquisition section 232 acquires the update software transmitted from the update server 30 (“YES” in step S1) and temporarily stores the update software in the temporary storage section 22 (step S2).

Next, the determination section 233A acquires latest operation status information of the devices (the outdoor units 11 and the indoor units 12) in the air conditioner unit 10 which has been acquired by the air conditioner unit management section 231 of the monitoring gateway device 20A (step S3). Based on the acquired information, the determination section 233A determines whether or not all the devices in the air conditioner unit 10 are operating normally (step S4).

If it is determined that all the devices in the air conditioner unit 10 are operating normally (“YES” in step S4), the determination section 233A determines that the possibility of abnormality occurring in air conditioning control is low, and that the necessity of monitoring the air conditioner unit 10 is low.

If the determination section 233A determines that the necessity of monitoring the air conditioner unit 10 is low, the update instruction section 234 determines that updating of the management software is possible, and sends an update instruction of the management software to the update processing execution section 235.

When the update processing execution section 235 obtains the update instruction, the update processing execution section 235 updates the management software in the management software storage section 21 by using the update software stored in the temporary storage section 22 (step S5).

If it is determined in step S4 that there is a device in the air conditioner unit 10 that is not operating normally (“NO” in step S4), the determination section 233A determines that there is a high possibility of abnormality occurring in the air conditioning control, and that the necessity of monitoring the air conditioner unit 10 is high. If the determination section 233A determines that the necessity of monitoring the air conditioner unit 10 is high, the update instruction section 234 does not send an update instruction. When a predetermined time elapses after the determination processing (“YES” in step S6), the determination section 233A executes the processing of steps S3 and S4 again. The processing of steps S3, S4, and S6 by the determination section 233A is repeated until the update by the update software is executed.

According to the first embodiment as described above, when the devices in the air conditioner unit are operating normally, and the necessity of monitoring the air conditioner unit is low, the update processing of the management software can be executed in the air conditioner unit management device that manages the air conditioner unit, as appropriate.

### Configuration of Air Conditioning System Using Air Conditioner Unit Management Device According to Second Embodiment

A configuration of an air conditioning system 1B using an air conditioner unit management device according to a second embodiment is the same as that of the air conditioning system 1A described in the first embodiment. Therefore, a detailed description of functional sections of the air conditioning system 1B and an air conditioner unit management device 100B according to the second embodiment are omitted.

### Operation of Air Conditioning System Using Air Conditioner Unit Management Device According to Second Embodiment

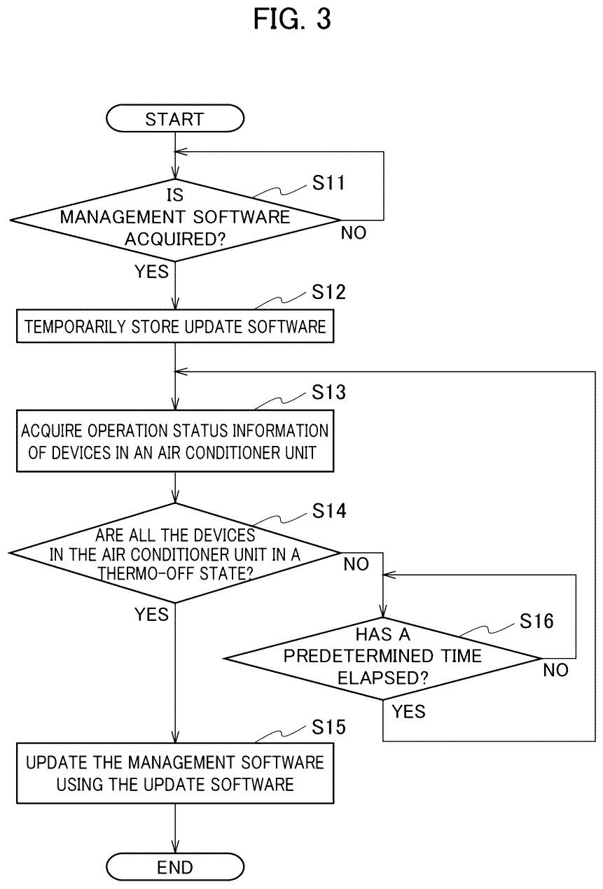

Next, operation of the air conditioning system 1B using the air conditioner unit management device 100B according to the present embodiment will be described. FIG. 3 is a flowchart illustrating operation performed by a monitoring gateway device 20B during the operation of the air conditioning system 1B.

In FIG. 3, processing executed in steps S11 to S13 is the same as the processing in steps S1 to S3 described in the first embodiment, and a detailed description thereof will be omitted. When a determination section 233B obtains latest operation status information of the devices in the air conditioner unit 10 in step S13, determination section 233B determines, based on the obtained information, whether or not all the devices in the air conditioner unit 10 are in a thermo-off state in which outdoor units including compressors stop operating and indoor units including indoor fans continue to operate (step S14).

If it is determined that all the devices in the air conditioner unit 10 are in the thermo-off state (“YES” in step S14), the determination section 233B determines that the possibility of abnormality occurring in the air conditioning control is low, and that the necessity of monitoring the air conditioner unit 10 is low.

When the determination section 233B determines that the necessity of monitoring the air conditioner unit 10 is low, the update instruction section 234 determines that updating of the management software is possible, and sends an update instruction of the management software to the update processing execution section 235.

When the update processing execution section 235 acquires an update instruction, the update processing execution section 235 updates the management software in the management software storage section 21 by using the update software stored in the temporary storage section 22 (step S15).

When it is determined in step S14 that there is a device in the air conditioner unit 10 that is not in the thermo-off state (“NO” in step S14), the determination section 233B determines that the possibility of abnormality occurring in air conditioning control is high, and that the necessity of monitoring the air conditioner unit 10 is high. When the determination section 233B determines that the necessity of monitoring the air conditioner unit 10 is high, the update instruction section 234 does not send an update instruction. When a predetermined time elapses after the determination processing (“YES” in step S16), the determination section 233B executes the processing of steps S13 and S14 again. The processing of steps S13, S14, and S16 is repeated by the determination section 233B until the update by the update software is executed.

According to the second embodiment described above, when all devices in the air conditioning system are in the thermo-off state and the necessity of monitoring the air conditioning system is low, the update processing of the management software can be executed in the air conditioner unit management device that manages the air conditioning system, as appropriate.

### Configuration of Air Conditioning System Using Air Conditioner Unit Management Device According to Third Embodiment

A configuration of an air conditioning system 1C using an air conditioner unit management device according to a third embodiment is the same as that of the air conditioning system 1A described in the first embodiment. Therefore, a detailed description of functional sections of the air conditioning system 1C and an air conditioner unit management device 100C according to the third embodiment is omitted.

### Operation of Air Conditioning System Using Air Conditioner Unit Management Device According to Third Embodiment

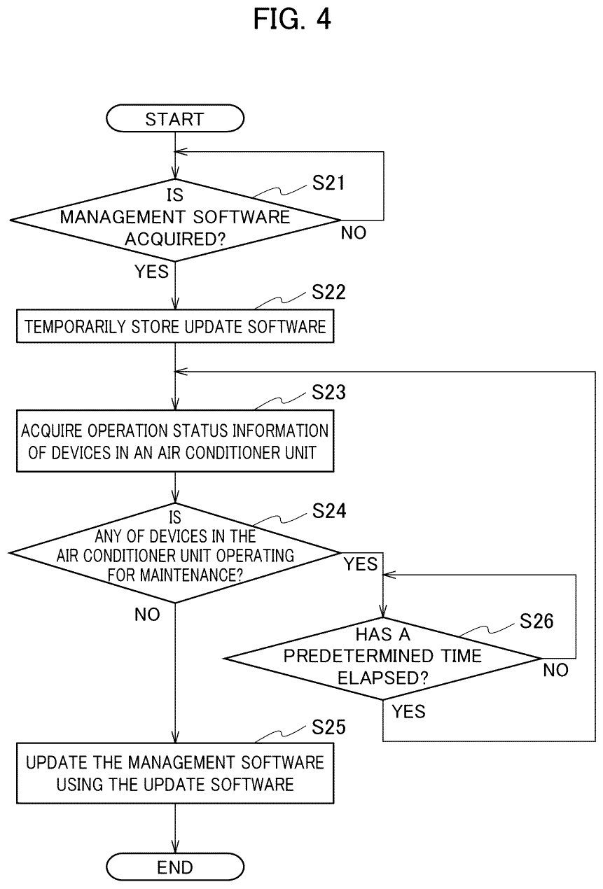

Next, operation of the air conditioning system 1C using the air conditioner unit management device 100C according to the present embodiment will be described. FIG. 4 is a flowchart illustrating operation performed by a monitoring gateway device 20C during the operation of the air conditioning system 1C.

In FIG. 4, processing executed in steps S21 to S23 is the same as the processing in steps S1 to S3 described in the first embodiment, and a detailed description thereof is omitted. When a determination section 233C acquires latest operation status information of the devices in the air conditioner unit 10 in step S23, it determines whether or not any of devices in the air conditioner unit 10 is operating for maintenance, based on the acquired information (step S24). Examples of operations for maintenance includes defrosting operation, oil recovery operation, refrigerant recovery operation, or the like.

If it is determined that none of the devices in the air conditioner unit 10 is operating for maintenance (“NO” in step S24), the determination section 233C determines that the necessity of monitoring the air conditioner unit 10 is low.

When the determination section 233C determines that the necessity of monitoring the air conditioner unit 10 is low, the update instruction section 234 determines that updating of the management software is possible, and sends an update instruction of the management software to the update processing execution section 235.

When the update processing execution section 235 acquires an update instruction, the update processing execution section 235 updates the management software in the management software storage section 21 by using the update software stored in the temporary storage section 22 (step S25).

If it is determined in step S24 that any of devices in the air conditioner unit 10 is operating for maintenance management (“YES” in step S24), the determination section 233C determines that there is a high possibility of abnormality occurring in the air conditioning control, and that the necessity of monitoring the air conditioner unit 10 is high. If the determination section 233C determines that the necessity of monitoring the air conditioner unit 10 is high, the update instruction section 234 does not send an update instruction. When a predetermined time elapses after the determination processing (“YES” in step S26), the determination section 233C executes the processing of steps S23 and S24 again. The processing of steps S23, S24, and S26 by the determination section 233C is repeated until the update by the update software is executed.

According to the third embodiment described above, the update processing of the management software can be executed in the air conditioner unit management device that manages the air conditioner, as appropriate, avoiding a case in which there is an operating device for maintenance management in the air conditioner and the necessity of monitoring the air conditioner is high.

### Configuration of Air Conditioning System Using Air Conditioner Unit Management Device According to Fourth Embodiment

A configuration of an air conditioning system 1D using an air conditioner unit management device of a fourth embodiment is the same as that of the air conditioning system 1A described in the first embodiment. Therefore, a detailed description of functional sections of the air conditioning system 1D and the air conditioner unit management device 100D of the fourth embodiment is omitted.

In the present embodiment, the indoor units 12 are each communicably connected to a remote controller (not illustrated), and a user can operate the indoor units 12 using the remote controller. The operation of the indoor units 12 performed by a user using the remote controller is called “hand operation”.

An air conditioner unit management section 231 of a monitoring gateway device 20D can switch the setting of permitting or prohibiting hand operation for the indoor units 12.

### Operation of Air Conditioning System Using Air Conditioner Unit Management Device According to Fourth Embodiment

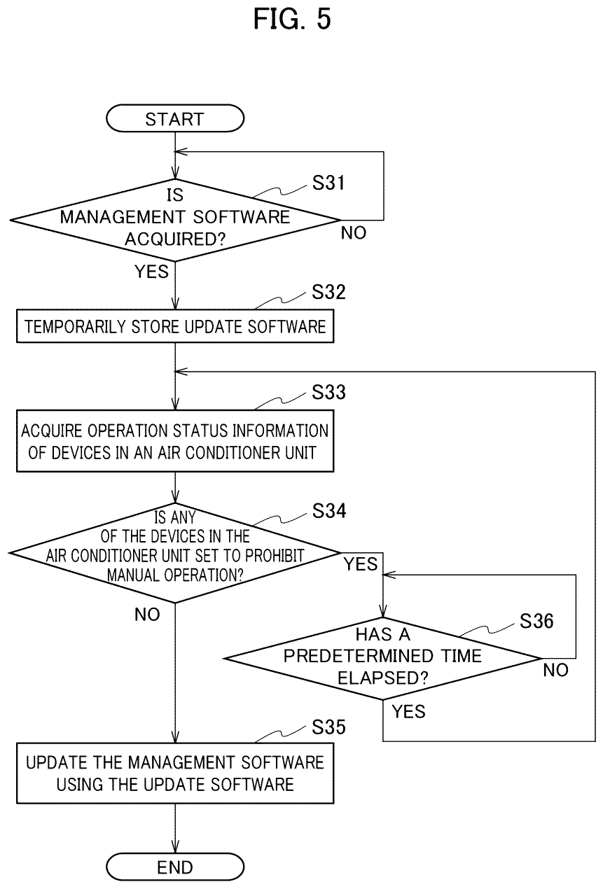

Next, operation of the air conditioning system 1D using the air conditioner unit management device 100D of the present embodiment will be described. FIG. 5 is a flowchart illustrating operation performed by the monitoring gateway device 20D during operation of the air conditioning system 1D.

In FIG. 5, processing executed in steps S31 to S33 are the same as the processing in steps S1 to S3 described in the first embodiment, and a detailed description thereof is omitted. When latest operation status information of the devices in the air conditioner unit 10 is acquired in step S33, a determination section 233D determines, based on the acquired information, whether or not any of the indoor units 12 in the air conditioner unit 10 is set to prohibit accepting a hand operation by the remote controller (step S34).

If it is determined that none of the indoor units 12 in the air conditioner unit 10 are set to prohibit accepting hand operation (“NO” in step S 34), the determination section 233D determines that the necessity of monitoring the air conditioner unit 10 is low.

If the determination section 233D determines that the necessity of monitoring the air conditioner unit 10 is low, the update instruction section 234 determines that updating of the management software is possible, and sends an update instruction of the management software to the update processing execution section 235.

When the update processing execution section 235 acquires the update instruction, the update processing execution section 235 updates the management software in the management software storage section 21 by using the update software stored in the temporary storage section 22 (step S35).

If it is determined in step S34 that any of the indoor units 12 in the air conditioner unit 10 is set to prohibit accepting hand operation (“YES” in step S34), the determination section 233D determines that the possibility of abnormality occurring in the air conditioning control is high, and that the necessity of monitoring the air conditioner unit 10 is high. If the determination section 233D determines that the necessity of monitoring the air conditioner unit 10 is high, the update instruction section 234 does not send an update instruction. When a predetermined time elapses after the determination processing (“YES” in step S36), the determination section 233D executes the processing of steps S33 and S34 again. The processing of steps S33, S34, and S36 by the determination section 233D is repeated until the prohibition of accepting the hand operation is released and the update by the update software is executed.

According to the fourth embodiment described above, the update processing of the management software can be executed in the air conditioner unit management device that manages the air conditioner unit, as appropriate, avoiding a case in which accepting the hand operation by the remote controller is prohibited in the air conditioner unit. Thus, when the control of the indoor units 12 by the air conditioner unit management section 231 becomes impossible during the update processing of the management software, a user can make the indoor units 12 execute the appropriate air conditioning by the hand operation as necessary.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An air conditioner unit management device communicably connected to an air conditioner unit, comprising:
a management software storage section configured to store management software for managing the air conditioner unit;
a determination section configured to determine necessity of monitoring the air conditioner unit, based on an operation status of the air conditioner unit; and
an update processing execution section configured to execute update processing of the management software by using update software when the update software for updating the management software is acquired, and when the determination section determines that the necessity of monitoring the air conditioner unit is low.

2. The air conditioner unit management device according to claim 1, wherein the determination section is configured to determine that the necessity of monitoring the air conditioner unit is low when all devices in the air conditioner unit are operating normally.

3. The air conditioner unit management device according to claim 1, wherein the determination section is configured to determine that the necessity of monitoring the air conditioner unit is low when all devices in the air conditioner unit are in a thermo-off state.

4. The air conditioner unit management device according to claim 1, wherein the determination section is configured to determine that the necessity of monitoring the air conditioner unit is high when any of devices in the air conditioner unit is operating for maintenance.

5. The air conditioner unit management device according to claim 1, wherein the determination section is configured to determine that the necessity of monitoring the air conditioner unit is high when any of devices in the air conditioner unit is set to prohibit accepting operation performed individually by a user using a remote controller.

6. An air conditioner unit management method using an air conditioner unit management device communicably connected to an air conditioner unit, comprising:
storing management software for managing the air conditioner unit; and
executing update processing of the management software by using update software when the update software for updating the management software is acquired, and when it is determined that the necessity of monitoring the air conditioner unit is low.
